(19) United States
(12) Patent Application Publication
(10) Pub. No.: US 2006/0120579 A1
(43) Pub. Date: Jun. 8, 2006

(54) Imaging apparatus and method

(76) Inventors: Ulf Skoglund, Stockholm (SE); Gosta Sjoholm, Stockholm (SE)

Correspondence Address: YOUNG & THOMPSON, 745 SOUTH 23RD STREET, 2ND FLOOR, ARLINGTON, VA, 22202, US

(21) Appl. No.: 10/520,508

(22) PCT Filed: Jun. 24, 2003
(86) PCT No.: PCT/SE03/01087

§ 371 Date: Oct. 6, 2005

Related U.S. Application Data
(60) Provisional application No. 60/394,276, filed on Jul. 9, 2002.

(30) Foreign Application Priority Data
Jul. 8, 2002 (SE) 0202130-1

(51) Int. Cl. G06K 9/00

(52) U.S. Cl. 382/128

(57) ABSTRACT

A method and apparatus for imaging of at least one object, the method includes the following steps:—collecting image information about a sample by means of a microscope,—selecting a part of the sample to be imaged (as a volume)—reconstructing the collected image information for the volume using an iterative reconstruction method in which a prior prejudice distribution is refined in at least one step on the basis of a comparison with the collected image information, preferably the Comet method. One or more objects may be selected within the volume for analysis of image information related to the at least one object.

### TECHNICAL FIELD

The present invention relates to an imaging apparatus according to the preamble of claim 1. The present invention also relates to an imaging method.

### BACKGROUND AND PRIOR ART

Several prior art methods exist for imaging and 3D reconstruction of small objects.

Stained material may be used either with a high radiation dose or a low radiation dose. In the case of a high dose the sample to be imaged suffers a mass loss of typically about 30%. With such techniques a resolution down to about 3 nm may be obtained. A higher resolution seems only fortuitous since the method introduces systematic errors. Parts of the object, such as fibres, are destroyed. Therefore the method can only be used in practice down to general cell components. It cannot be used for imaging objects as small as individual molecules of less than 100-200 kDa in molecular weight.

Low dose stained material can reach a resolution down to approximately 5 nm. There is no mass loss, that is, the sample remains intact. The noise level in the image is quite high, which makes the image hard to interpret. Individual molecules cannot be identified.

Unstained material cannot normally be studied in situ because of problems in identifying and preparing the samples. A sample may be studied in a solution by creating a thin film of buffer that can be imaged. The highest possible resolution is 6-8 nm, that is, very large molecule complexes can be studied in three dimensions.

Auer, Manfred: “Three-dimensional electron cryo-microscopy as a powerful structural tool in molecular medicine”, Journal of Molecular Medicine, DOI 10.1007/s001090000101, published online 28 Apr. 2000, discusses methods for cryo-microscopy for structure determination of protein molecules, protein complexes and cell organelles. Table 1 of this article lists medically relevant protein structures determined by electron microscopy and image reconstruction. The resolution ranges from 3.7 Å for tubulin to 30 Å for actin-myosin complexes. In the final chapter, “The future prospects of electron microscopy”, Auer explains that structure of single particle objects with internal symmetry and expresses the desire among cell biologists to obtain high-resolution 3-D reconstructions of particles without internal symmetry. He also outlines a future possibility of studying the 3-D structure of large macromolecular assemblies, without indicating how this can be achieved, except that improved computing power will be needed. Mellwig and Böttcher: “Dealing with Particles in Different Conformational States by Electron Microscopy and Image Processing”, Journal of Structural Biology 133, 214-220 (2001) describes the use of electron microscopy and image processing for investigating different conformational states of enzymes. Molecules having a molecular mass of about 550 kDa were investigated, i.e. relatively large molecules. The resolution achieved when averaging was applied ranged from 3.3nm to 4.8 nm.

There is a desire today for a method enabling the study of objects down to the size of single molecules. For example in the development of new medicines, knowledge of the binding and interaction sites of molecules is often helpful. This requires a higher resolution than what is generally available today and also a technique that enables the preparation of a sample without destroying the object.

### OBJECT OF THE INVENTION

It is therefore an object of the invention to enable the identification of individual 3-D structures or key components of a body, cell or molecule to a higher resolution and preserving more detail than has been possible in the prior art.

### SUMMARY OF THE INVENTION

This object is achieved according to the invention by a method for imaging of at least one object, comprising the following steps:
collecting image information about a sample by means of a microscope,
selecting a part of said sample to be imaged (as a volume)
reconstructing the collected image information for said volume using an iterative
   reconstruction method in which a prior prejudice distribution is refined in at least one step on the basis of a comparison with the collected image information

The object is also achieved by an apparatus for imaging of at least one object comprising the following steps:
means for receiving image information collected by means of a microscope,
means selecting a part of said sample to be imaged (as a volume)
means for reconstructing the collected image information for said volume using
   an iterative reconstruction method in which a prior prejudice distribution is refined in at least one step on the basis of a comparison with the collected image information

The method and apparatus according to the invention enables the study of small objects such as key components of a body, cell or molecule to a resolution down to the order of magnitude of 0.5 nm. In some cases, especially in combination with other methods, the resolution may increase to the order of magnitude of to 0.2-0.3 nm. Individual molecules down to below 20 kDalton can be studied.

The apparatus and method according to the invention enables the study of, for example, the following, in 2, 3 or up to N dimensions, N being a large positive integer. Small molecules and macromolecules, such as proteins, glycoproteins, general polymers and supramolecular complexes.
Key components in the signal transduction pathway.
Key components in the metabolic pathway
Key components in the neurobiology and developmental biology fields
Key components in the apoptosis sequence
Key components in the cell pathological changes (i.e. oncology)
Key components regarding effects of drugs
   With the method and apparatus according to the invention, such key components, including receptors and ion channels, may be studied individually in almost any medium.

The method and apparatus of the invention also enables the comparison of such structures or key components under different conditions, for example comparing health and disease conditions affected by a drug or exploring the conformational space of a macromolecule in a given medium.

The method preferably comprises the further steps of
selecting at least one object within said volume
analyzing a part of the image information related to said at least one object. In this case, the apparatus further comprises
means for selecting at least one object within said volume
means for analyzing a part of the image information related to said at least one object.

One or more objects can be selected in dependence of the shape and/or size of the object, in which case the apparatus comprises means for selecting the at least one object in dependence of the shape and/or size of the object.

The method may also comprise steps for preparing the sample, such as exposing the sample to markers before collecting the image information, preparing the sample by means of cryomicrotomy and/or preparing the sample by means of flash freezing.

The method may also comprise the step of measuring the information content of the reconstructed image information. In this case the apparatus comprises data processing means for measuring the information content of the reconstruction produced by the first computer program.

The step of collecting image information preferably comprises collecting several 2D-images and aligning the 2D-images.

The reconstruction may be displayed on a computer screen. The reconstruction means for reconstructing the collected image information may be arranged to reconstruct 3D-data from said 2D-images without deconvoluting the point spread function. Alternatively, the reconstruction means may be arranged to reconstruct 3D data from said 2D-images including deconvoluting the point spread function. A third option is that the reconstruction means is arranged to first deconvolute the point spread function for the 2D-images and then reconstruct 3D-data without deconvoluting the point spread function.

The apparatus may comprise other processing and/or memory means, such as
auxiliary memory means for storing other data regarding the sample
structure memory means (8) for storing prior structure data
   data processing means (15) for combining the reconstructed or measured data output from the first computer program (6) with the prior structure data comprised in the structure data base (8) to refine the reconstructed image.

The inventive method and apparatus may be used for studies of the binding and interaction sites of molecules or key components such as proteins. Such studies, and also the above mentioned comparison, may be followed by, preceded by or combined with studies and analyses by other drug discovery methods to increase the resolution, for example, drug discovery methods and other physical or chemical methods.

The resolution depends, among other things, on the temperature of the sample. The lower the temperature of the sample, the higher resolution can be achieved. A common cooling agent today is liquid nitrogen. Liquid helium is more expensive, and therefore less common, but enables a higher resolution because it has a lower temperature.

Another factor limiting the resolution is the properties of the detectors used. With the detectors available today a higher resolution may be achieved for objects that are not sensitive to radiation. Normally, the object can only be exposed to a certain amount of radiation, which limits the number of images that can be captured of the object. If there is no such limitation, the method and apparatus of the invention can achieve a resolution down to less than 0.1 nm with prior art detectors.

Preferably, the Comet technology, as described in the International Patent Application WO97/33255, hereby incorporated by reference, (corresponding European Patent Application EP 885 430 and Swedish Patent Application 9601229-9) is used for image reconstruction.

The Comet technology is based on the following steps:
An initial estimated distribution of the sample is provided
A blurred prior prejudice distribution is provided based on the estimated distribution
Observed data of the sample is provided
In an iterative process a calculating means calculates, for each iteration, a new estimated distribution of the sample using a comparison between the estimated distribution and the observed data of the sample. A new prior prejudice distribution less blurred than the previous one is also calculated.
The iterations are continued until the difference between the new estimated distribution and the next preceding estimated distribution is less than a predetermined condition.

The use of the Comet technology enables an object to be studied in different media in the state in which it naturally exists in each medium. Therefore, the environment can be selected to provide the object in the desired state by selecting the appropriate medium, or environment. Alternatively, several different media may be used, to obtain data about the object in different states. Comet can be used for molecules both in situ and in solutions. Therefore, using Comet a 3D model of the object in its natural state may be achieved. In contrast, using crystallography, an object can only be studied in an environment in which it crystallizes. The structure obtained in this way may not even exist in a natural state. Hence, the data obtained from a crystallized object are less useful than data regarding an object in its natural state.

Using the Comet technology high-dose methods with stained material can achieve a resolution of 2-3 nm, that is, the same order of magnitude as today. Low-dose methods can achieve a resolution of 2-3nm. Comet therefore enables the study of molecules in situ in this case. With unstained material Comet enables a resolution in buffer solutions down to approximately 2nm, which is a great improvement compared to the prior art.

Alternatively, a method based on the fundamental principles of the Comet method may be used. For example, certain components in some subroutines may be replaced to extend the number of search directions to include other or more criteria than just the entropy. The effect of each operator on the search directions can be modified.

In all these cases the resolution may be further improved by means of averaging. With the inventive apparatus and method, however, individual parts of a sample may be analyzed with the improved resolution discussed above. The term “individual” means that the analysis is referred to one single object, as opposed to methods involving averaging between observations of several objects of the same kind. Thus, the inventive method enables the analysis or imaging of data based on one single object with the resolutions discussed above.

The term “singular”, on the other hand, does not exclude the use of averaging between observations of several objects.

The method according to the invention optimizes the integrity of the sample and of the processing.

### BRIEF DESCRIPTION OF THE DRAWINGS

The present invention will be described in more detail in the following, with reference to the appended drawings, in which:

FIG. 1 shows a flow chart of steps that are performed according to the invention, and

FIG. 2 shows an apparatus according to the invention for carrying out the method described in FIG. 1.

### DETAILED DESCRIPTION OF EMBODIMENTS

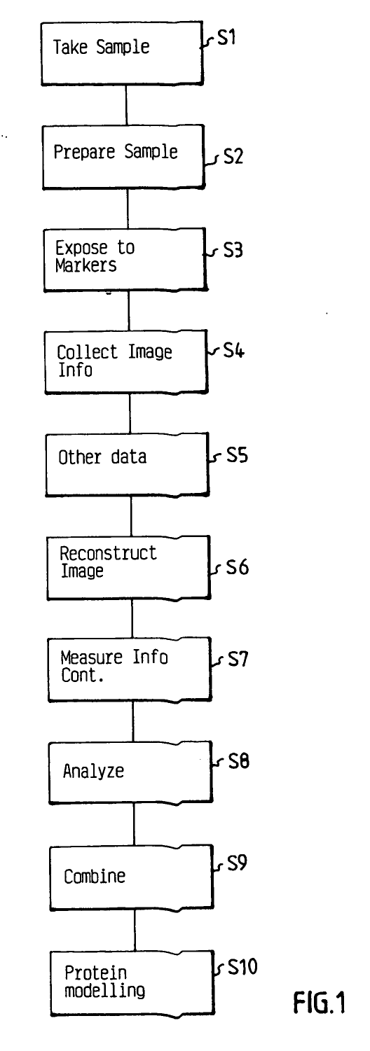

FIG. 1 shows a flow chart of steps that are performed according to the invention.

Some of the steps are optional.
Step S1: Take a sample. This is done according to any known method that enables gentle sample treatment, relevant to the degree of resolution wanted. Examples of methods are biopsy or putting a macromolecule into a buffer.
Step S2: Prepare the sample for microscopy, for example by providing a thin slice of the sample. Cryoultramicrotomy or flash-freezing may be used.
Step S3: (optional) Expose the sample to markers (for example antibodies) if desired. If this requires the thawing of the sample, it may be frozen again if necessary. Alternatively the sample may be exposed to markers before step 2.
Step S4: Collect image information and, if desired, other information) or data in a microscope to enable molecular analysis. See below for detail.
Step S5: (optional) Measure other data or information in other process steps related or unrelated to the microscope steps.
Step S6: Reconstruct the image information collected in step S4. This may be carried out according to the Comet method, or a modified method, as outlined above, See below for detail.
Step S7: (optional) Measure the information content of the reconstruction obtained in step S6.
Step S8: Analyze the reconstructed and measured data. This can be done according to prior art techniques.
Step S9: (optional) Combine the reconstructed or measured data with prior structure data, or with data obtained using NMR or crystallography.
Step S10: Protein modelling based on prior data, that is, using a protein model together with the 3D reconstruction obtained through steps S1-S6.

In step S1, taking a sample could also include the following activities related to the treatment of sample: fixation, cryoprotection, staining, freezing, cryosectioning or high-pressure freezing.

In steps S4 and S6 above the Comet technology as defined in European Patent Application EP 885 430 may be used, as will be discussed in the following.

The order of steps S4 and S5 above may be reversed to automate the process.

In step S4, possible additional steps include:
Detector properties regarding flat fielding etc,
Dimensions of the sample,
Finding the relevant area of the sample at low magnification
Calibration of the magnification
Electron dose determination
Preliminary determination of focus before collecting image data

In step S5, possible additional steps include:
Electron energy loss spectroscopy
Determining the focus of each image
Determining a point spread function that reflects the properties of both the specimen and the microscope

In step S6 the image information is reconstructed either by refining the information according to Comet including deconvoluting based on all data or images, or by using Comet to deconvolute the data of each 2-D image and then refining. Three main methods may be used:
The 3-D data may be reconstructed from said 2-D images without deconvoluting the point spread function.
The 3-D data may be reconstructed from said 2-D images including deconvoluting of the point spread function.
The 2D images may be processed, including deconvoluting of the point spread function, before the 3D data is reconstructed. Deconvolution is not used in the reconstruction of 3D data in this case.

The second method gives the best result. The third method, that is, applying Comet to 2D images has the advantage that it is easier to use together with prior art analysis and imaging programs. Alternatively, if the 2D images are processed, the 3D data do not have to be reconstructed if it is satisfactory to work only with the 2D projections.

When combining the 2D images to 3D they must be aligned. This may be done according to any method known in the art, for example by using gold markers placed in the sample. In step S7 measurements may include, for example, signal to noise (S/N) ratio. The set of data may be segmented based on quality to numerically characterize data by means of statistics or similar methods. Data mining may be applied by selecting for further studies all parts of the image that fulfil a certain criterion, for example
Parts that take up at least a certain number of continuous pixels,
Parts that have at least a certain volume,
Parts that can be projected in a certain shape,
Structures having a particular intensity distribution

In step S8 the reconstructed and measured data may be analyzed manually or by means of a computer. Based on the data mining carried out in step S7 objects or parts of objects may be selected and analyzed and/or visualized. Several programs for such analysis and visualization exist.

In step S9, for example, pseudo-atomic resolution can be achieved if form/structure data determined by one or several steps above are combined with structural data determined by crystallographic methods for correlation and averaging of the structure. Flexible docking may be applied, i.e. modifying the objects before the combination of data. Alternatively form/structure data determined by one or several steps above may be combined with structural data determined by structure or protein modelling methods.

The object may be classified based on topologic comparison. The model for comparison can be provided in several different ways, for example, from a computer-aided design of the structure of a protein.

A more detailed description of the mathematical basis for the Comet technology is given in European Patent Application EP 885 430, especially on page 14, 1.25-p. 28.

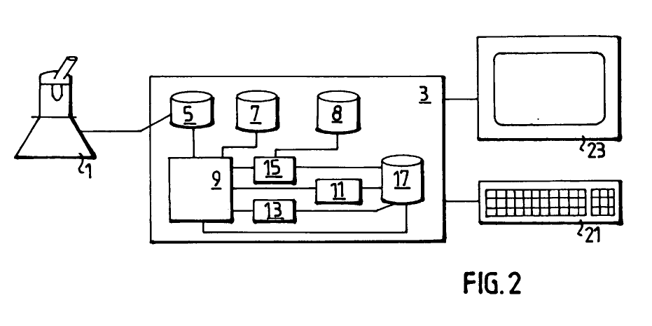

FIG. 2 shows an apparatus according to the invention for carrying out the method described in FIG. 1.

A microscope 1 is used for collecting image information about a sample. The microscope must either be able to collect tomographic information about the object or, if the imaging does not follow tomographic principles, the physical deformation that takes place in the imaging process must not disable the interpretation of the images. The deformation may be compensated for in Comet, if the deformation can be described.

The sample has been taken and prepared as outlined in steps S1-S3 of FIG. 1. A computer 3 is used for storing and processing the image information. The image information collected by the microscope 1 is stored in an image memory means 5. Other data or information, for example as discussed in connection with steps S4 and S5 above, may be input to the computer and stored in an auxiliary memory means 7. A structure data memory means 8 may be present, comprising, prior structure data, for example, obtained using NMR or crystallography, which may be used for refining the result.

A first computer program 9 in the computer 3 works on the data in the image memory means 5 to reconstruct the image information collected by the microscope 1. The first computer program 9 works, for example, according to the Comet method outlined above. A second computer program 11 may be present, which measures the information content of the reconstruction produced by the first computer program 9. A third computer program 13 analyzes the reconstructed and measured data, which may be done according to prior art techniques. For example, the third program 13 can identify objects having a certain shape or size. The third program 13 can also perform virtual reorientation of objects, for example, so that all objects of a similar structure are shown with the same orientation. Optionally, a fourth computer program 15 may be present to combine the reconstructed or measured data output from the first computer program 6 with the prior structure data comprised in the structure database 8. The output from each of the programs 9, 11, 13, 15 may be stored in a result database 17.

The computer may be operated through operator input means 21. FIG. 2 shows a keyboard, but of course any available operator input means may be used. The computer also has a computer screen 23, for communicating with the operator. The reconstruction produced by the first computer program may be displayed on the computer screen 23.

Of course, the computer programs 9, 11, 13, 15 do not have to be written as individual programs but can be implemented as one or more programs in a program structure that is seen as appropriate. The memory means 5, 7, 8, 17, also, can be combined or divided, as is seen fit. Further memory means may be needed, for example, for storing resulting data from one or more of the computer programs 9, 11, 13, 15.

1-26. (canceled)

27. A method for imaging of at least one object, comprising the following steps:
collecting image information about a sample by means of a microscope,
selecting a part of said sample to be imaged as a volume
reconstructing the collected image information for said volume using an iterative reconstruction method in which a prior prejudice distribution is refined in at least one step on the basis of a comparison with the collected image information.

28. A method according to claim 27, further comprising the steps of
selecting at least one object within said volume
analyzing a part of the image information related to said at least one object.

29. A method according to claim 27, wherein said reconstruction method is based on the COMET technology.

30. A method according to claim 27, further comprising the step of selecting the at least one object in dependence of the shape and/or size of the object.

31. A method according to claim 27 further comprising the step of exposing the sample to markers before collecting the image information.

32. A method according to claim 27 further comprising the step of measuring the information content of the reconstructed image information.

33. A method according to claim 27 wherein the step of collecting image information comprises collecting several 2D-images and further comprising the steps of aligning the 2D-images.

34. A method according to claim 27 wherein the step of reconstructing the collected image information comprises reconstructing 3D-data from said 2D-images without deconvoluting the point spread function.

35. A method according to claim 27, wherein the step of reconstructing the collected image information comprises reconstructing 3D data from said 2D-images including deconvoluting the point spread function.

36. A method according to claim 27, wherein the step of reconstructing the collected image information comprises first deconvoluting the point spread function for the 2D-images and then reconstructing 3D-data without deconvoluting the point spread function.

37. A method according to claim 27, further comprising the step of preparing the sample by means of cryomicrotomy.

38. A method according to claim 27, further comprising the step of preparing the sample by means of flash freezing.

39. A method according to claim 27 further comprising the step of displaying the reconstruction on a computer screen.

40. An apparatus for imaging of at least one object comprising the following steps:
means for receiving image information collected by means of a microscope,
means selecting a part of said sample to be imaged as a volume
means for reconstructing the collected image information for said volume using an iterative reconstruction method in which a prior prejudice distribution is refined in at least one step on the basis of a comparison with the collected image information.

41. An apparatus according to claim 40, further comprising
means for selecting at least one object within said volume
means for analyzing a part of the image information related to said at least one object.

42. An apparatus according to claim 40, wherein said means for reconstructing the collected image information is arranged to apply a reconstruction method based on the COMET technology.

43. An apparatus according to claim 40, further comprising means for selecting the at least one object in dependence of the shape and/or size of the object.

44. An apparatus according to claim 40, further comprising measuring means (11) for measuring the information content of the reconstructed image information.

45. An apparatus according to claim 40, further comprising aligning means for aligning several 2D-images related to a sample.

46. An apparatus according to claim 40, wherein said reconstruction (9) means for reconstructing the collected image information is arranged to reconstruct 3D-data from said 2D-images without deconvoluting the point spread function.

47. An apparatus according to claim 40, wherein the means for reconstructing the collected image information is arranged to reconstruct 3D data from said 2D-images including deconvoluting the point spread function.

48. An apparatus according to claim 40, wherein the means for reconstructing the collected image information is arranged to first deconvolute the point spread function for the 2D-images and then reconstruct 3D-data without deconvoluting the point spread function.

49. An apparatus according to claim 40, further comprising data processing means (11) for measuring the information content of the reconstruction produced by the first computer program (9).

50. An apparatus according to claim 40, further comprising auxiliary memory means (7) for storing other data regarding the sample.

51. An apparatus according to claims 40, further comprising structure memory means (8) for storing prior structure data.

52. An apparatus according to claim 40, further comprising data processing means (15) for combining the reconstructed or measured data output from the first computer program (6) with the prior structure data comprised in the structure data base (8) to refine the reconstructed image.
